(19) United States
(12) Patent Application Publication
(10) Pub. No.: US 2007/0044643 A1
(43) Pub. Date: Mar. 1, 2007

(54) Method and Apparatus for Automating the Mixing of Multi-Track Digital Audio

(76) Inventor: Eric Christopher Huffman, Chicago, IL (US)

Correspondence Address: WHITE-WELKER & WELKER, LLC, P.O. BOX 199, CLEAR SPRING, MD, 21722-0199, US

(21) Appl. No.: 11/466,574

(22) Filed: Aug. 23, 2006

Related U.S. Application Data
(60) Provisional application No. 60/712,162, filed on Aug. 29, 2005.

(51) Int. Cl. G10H 1/08; G10H 7/00

(52) U.S. Cl. 84/625

(57) ABSTRACT

The present invention enables producers of music to take audio data that has been generated within a commercially available Digital Audio Workstation (DAW) and then apply the method and apparatus of the present invention to create an Adaptable Music File. This Adaptable Music File may then be used to produce suitable music mixes based on user specified values for descriptive parameters that are tailored to users without music expertise, for example foreground, background, intense, light, dense, and sparse. The Adaptable Music File created by the present invention may be used with other Adaptable Music Files to create new suitable music mixes based on user specified values for descriptive parameters that are tailored to users without music expertise.

### CROSS REFERENCE TO RELATED APPLICATIONS

This application claims priority from U.S. Provisional Patent Application Ser. No. 60/712,162, entitled “Method and Apparatus for Automating the Mixing of Multi-Track Digital Audio”, filed on Aug. 29, 2005.

### FEDERALLY SPONSORED RESEARCH

Not Applicable

### TECHNICAL FIELD OF THE INVENTION

The present invention relates generally to digital audio. More specifically the present invention relates to a method and apparatus for automating the mixing of multi-track digital audio.

### PROGRAM APPENDIXES

Appendix A lists pseudocode comprising program headers and implementation necessary to explain the performance of each of the processes that make up the program of the preferred embodiment used by the system of the present invention; and
Appendix B lists pseudocode comprising data structures necessary to explain the package description file to tag a song with a descriptive meta-data that makes up the main component of the program of the preferred embodiment used by the system of the present invention.

### BACKGROUND OF THE INVENTION

Music is used in a variety of products and works. For example, music is often used in web applications, computer games, and other interactive multimedia products. Music is also often used in other works such as television advertising, radio advertising, commercial films, corporate videos, and other media.

Working with music during the production of products and works that use music can be complicated and time consuming. In a first example, if the music in use is from a music library, it usually has been mixed from a multi-track composition, so the various instruments and other musical elements are fixed and cannot be changed by a user of music. In a second example, when a user of music requires that the music be mixed differently, the user must engage in the costly and time consuming task of either licensing the original multi-track music project, or contracting a composer to attempt to reproduce the music with the desired changes.

If a user of music has access to a multi-track music project, the user must have expert audio engineering skills and must have a significant amount of time available in order to create an acceptable music mix. It is therefore an objective of the present invention to teach a method and apparatus for automating the mixing of multi-track digital audio.

If a user of music has access to several multi-track music projects, and wishes to create a new song by combining various tracks from the several multi-track music projects, the user must have expert audio engineering skills and must have a significant amount of time available in order to create an acceptable music mix. It is therefore an objective of the present invention to teach a method and apparatus for automating the mixing of multi-track digital audio.

Others have attempted to solve the same and similar issues presented above, but have failed in accomplishing these objectives. For example, U.S. Pat. No. 6,066,792 teaches a music apparatus performing joint play of compatible songs; U.S. Pat. No. 5,009,145 teaches an automatic performance apparatus having automatic synchronizing function; U.S. Pat. No. 6,916,978 teaches a system and method for creating, modifying, interacting with and playing musical compositions; and U.S. Pat. No. 6,889,193 teaches a method and system for smart cross-fader for digital audio.

### SUMMARY OF THE INVENTION

In accordance with the present invention a method and apparatus for automating the mixing of multi-track digital audio that overcomes the aforementioned problems of the prior art.

The present invention enables producers of music to take audio data that has been generated within a commercially available Digital Audio Workstation (DAW) and then apply the method and apparatus of the present invention to create an Adaptable Music File. This Adaptable Music File may then be used to produce suitable music mixes based on user specified values for descriptive parameters that are tailored to users without music expertise, for example foreground, background, intense, light, dense, and sparse.

The Adaptable Music File created by the present invention may be used with other Adaptable Music Files to create new suitable music mixes based on user specified values for descriptive parameters that are tailored to users without music expertise.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the data structures of the present invention;

FIG. 2 is a flow chart illustrating the program steps 1-7 of the present invention;

FIG. 3 is a flow chart illustrating the program steps 8-10 of the present invention;

FIG. 4 a flow chart illustrating the program steps 11-16 of the present invention; and

FIG. 5 is a diagram of the present invention's various physical components.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

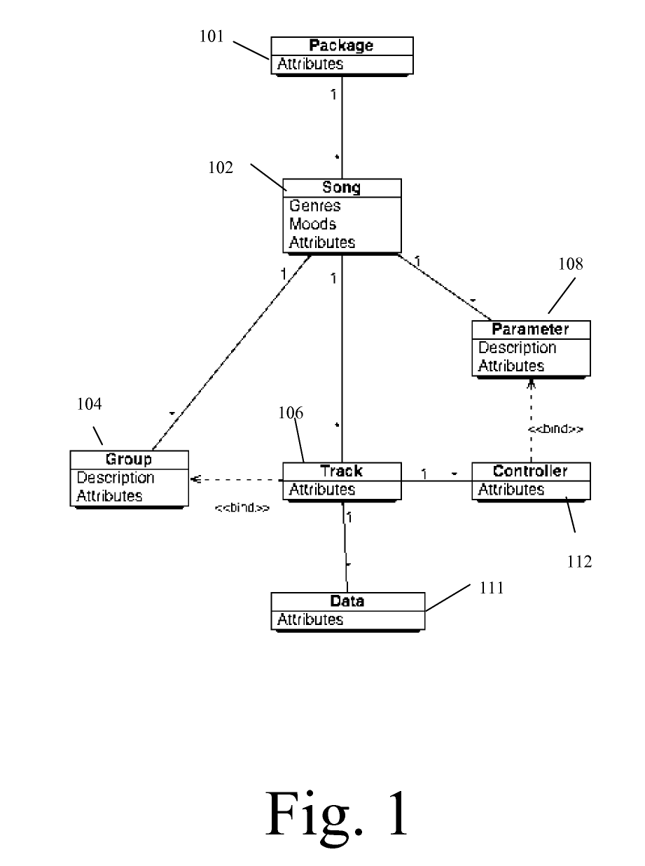

Referring to FIGS. 1 thru 5, it is possible to see the various major elements constituting the apparatus of the present invention and its method of use. The invention is a method and apparatus for automating the mixing of multi-track digital audio.

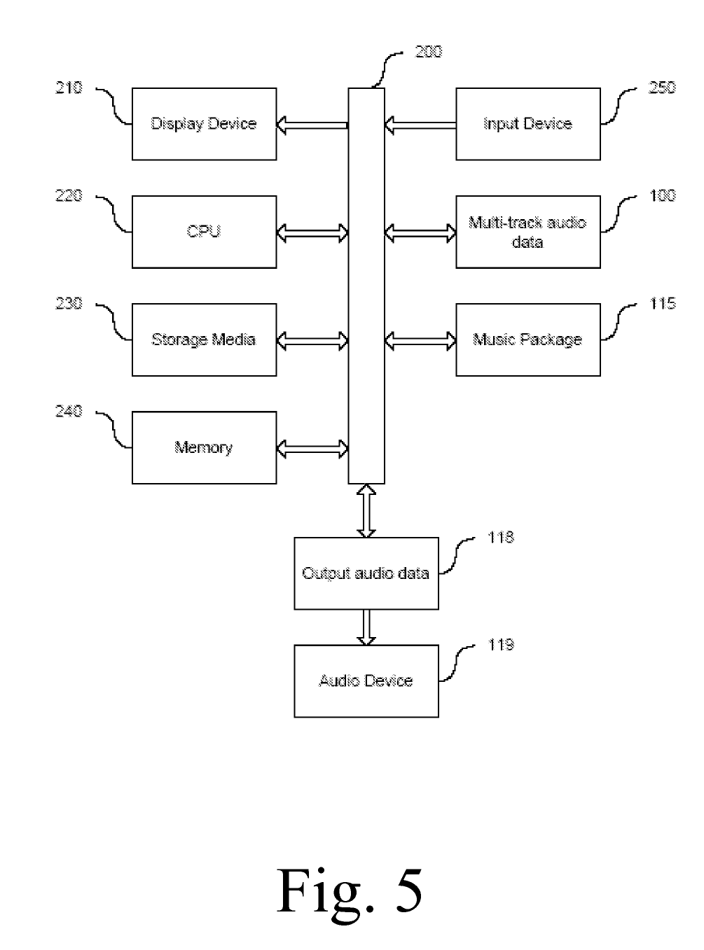

Referring to FIG. 5, a diagram of the present invention's various physical components is illustrated. The physical embodiment of the present invention is that of a computer which is running the method, embodied in software, to take user input and create the desired output.

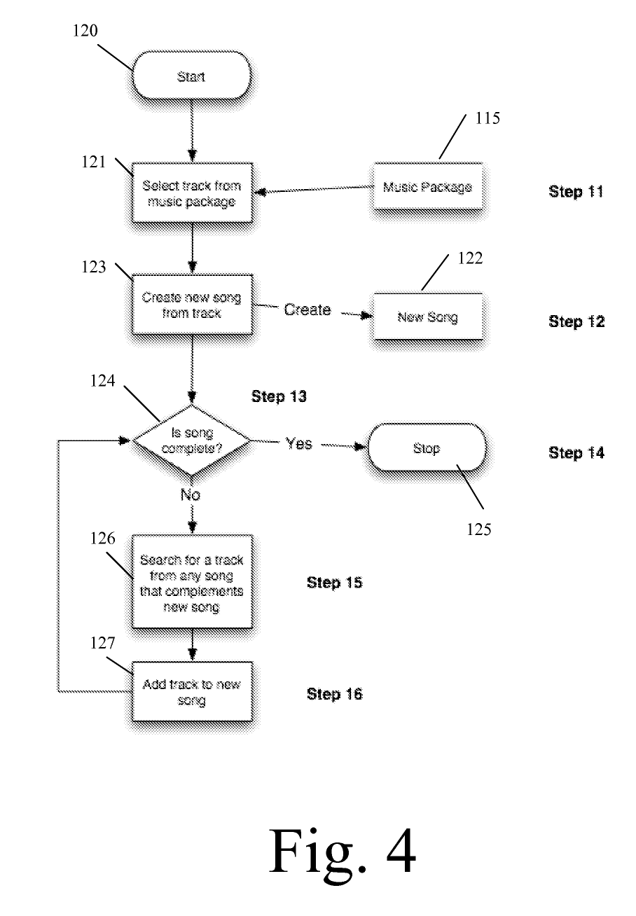

The physical embodiment of the invention is a computer-based system of interacting components. The major physical elements are: a buss 200 which allows various components of the system to be connected or wired; an input device 250 such as a keyboard or mouse provides user input utilized by the system; a display device 210 such as a video card and computer screen provides the user with visual information about the system via a user interface; a CPU 220 of sufficient processing power handles the system's processing; storage media 230 stores the program steps as described in FIGS. 1-4 for the system's processing; and a memory 240 of sufficient size which stores any data resulting from, or for, the system's processing.

Still referring to FIG. 5, the buss 200, CPU 220, storage media 230, memory 240, input device 250, and display device 210 will preferably be components of a computer. The audio device 119 may be a component of the computer but may also be a device external to the computer such as a digital to analog audio converter. The audio device 119 is preferably connected to other devices, such as an audio amplifier and speakers. The output audio data 118 is in a format suitable for the audio device 119 to produce audio. The output audio data 118 format may be a sequence of floating point numbers representing multi-channel audio.

The buss 200, CPU 220, storage media 230, memory 240, input device 250, display device 210, output audio data 118, and audio device 119 are well-known components to those with ordinary skill in the electronic and mechanical arts, but their novel and non-obvious combination in the present invention with the method for Automating the Mixing of Multi-Track Digital Audio of the present invention improves upon the prior art.

The method or arrangement of wiring or connecting these components in a manner that is suitable for the operation of the system is also well known to those with ordinary skill in the electronic and mechanical arts.

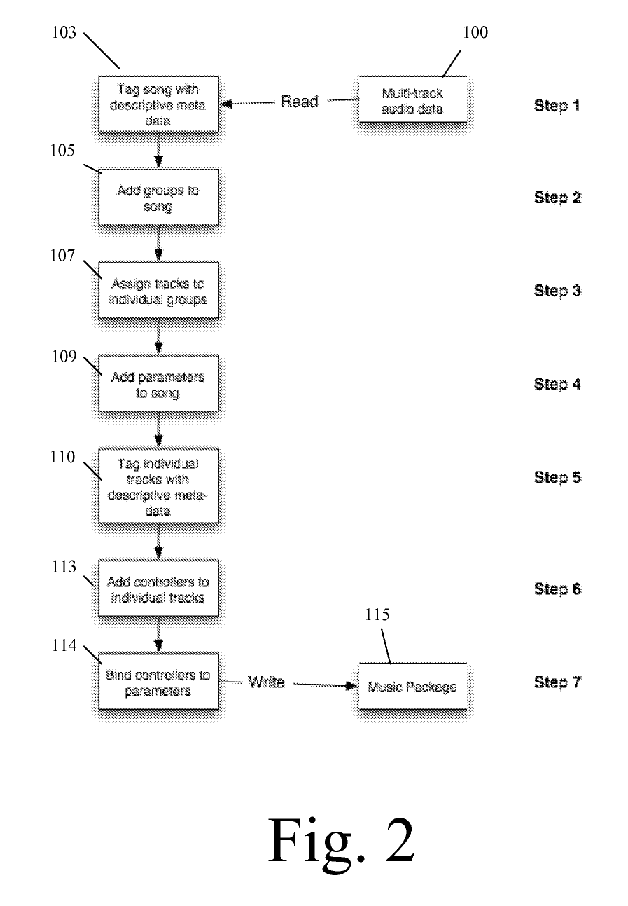

Referring to FIG. 2, Specifically, in step 1 present invention reads a song, also known as a multi-track audio project 100 and uses a package description file 101 to tag the song 102 with descriptive meta-data 103 such as a name, genre, or mood.

Now referring to steps 2 & 3, Groups 104 are added 105 to the song 102 through use of the package description file. These groups 104 may combine various tracks 106 with similar or shared characteristics 107 such as drums, voices, or guitars.

In step 4 Parameters 108 are added 109 to the song 102 through use of the package description file. The parameters 108 are like music controls with descriptive names and may not require any music expertise to use such as music intensity, density, percussiveness, and sharpness.

In step 5, individual tracks 106 are tagged 110 with meta-data 111 through use of the package description file. This meta-data 111 may include information such as the typical amplitude envelope for instruments in that track, as well as tempo, key, note and measure regions, etc.

In step 6, Controllers 112 are added to the tracks 113 through use of the package description file. Associated with the controllers 112 are attributes that may govern how the controller 112 affects the associated track 106 when a music mix 117 is performed.

In step 7, controllers 112 are bound to parameters 114 through use of the package description file. When the controllers 112 are bound to the parameters, the parameters provide values that the controllers 112 use when they affect the tracks 106 as a music mix is performed. This allows the user to have descriptive control, through the use of the parameters 108 and controllers 112, over an entire music mix 117.

Now referring to steps 8, 9, & 10 a music mix 117 may be performed or calculated 117 for the user specified values for each parameter 116, resulting in an audio file 118 that may be played over a sound reproduction system 119 or stored in an information retrieval system for later use.

Once a song and it's associated tracks are tagged, parameters are added, controllers are added and bound, and the user has specified values for the parameters, it is possible to generate new songs from the various tracks of some number of songs. This is done via the following steps.

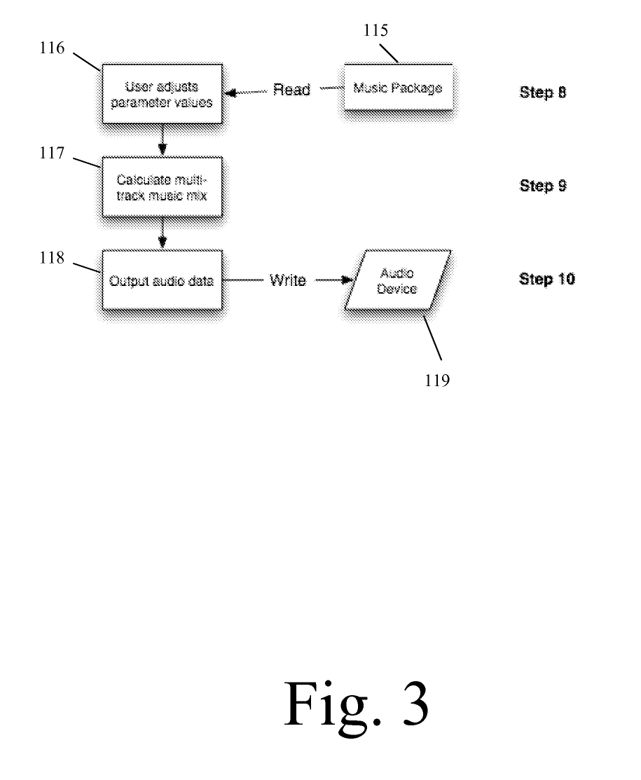

Now referring to FIG. 3 and step 11, the process starts 120 when a track 106 is selected 121 from an existing song 102. The selection 121 may be performed by the user, or by some algorithmic method such as a search based on genre or mood.

In step 12 a new song 122 is created 123 with the selected track. This new song 122 has one track, the selected track. Next, a test is performed 124 in step 13 to determine if the song is complete. A song may be considered to be complete when two cases are considered to be true. First, the song has enough tracks such that all of the song parameters affect the music mix. For example, if any change in the value of a Intensity parameter has no effect on the output of a music mix, then the song is not complete. However, if any change in the value of all parameters has an effect on the output of the music mix, then the first completion case is true. Second, all tracks should be considered to be suitable for combination given some set of musical criteria such as tempo, pitch, etc.

In step 14, if the test succeeds, then the process stops 125 and a new song has been created that is considered to be complete. If the test does not succeed, then in step 15 the search for a new track is started 126 a new track is selected for addition to the song 127 and the process proceeds to step 13 and repeats until stopped 125.

Therefore, it should be understood that the method and apparatus of the invention can be practiced with modification and alteration within the spirit and scope of the appended claims. The description is thus to be regarded as illustrative instead of limiting on the invention.

### EXAMPLE PSEUDO-CODE IMPLEMENTATIONS

The following pseudo-code segments are provided to aid in understanding the various parts of the present invention. They should not be construed as complete or optimal implementations. Note that these codes illustrate the operation of the basic system described above, without any of the additional enhancements discussed. Although given as software code, the actual implementations may be as stored-program(s) used by a processor, as dedicated hardware, or as a combination of the two.

The embodiments of the invention in which an exclusive property or privilege is claimed are defined as follows:

1. Method for Automating the Mixing of Multi-Track Digital Audio comprising the following steps:
(A) a package description file tags a song with descriptive meta-data;
(B) groups are added to the song through use of the package description file;
(C) parameters are added to the song through use of the package description file;
(D) individual tracks are tagged with descriptive meta-data through use of the package description file;
(E) controllers are added to the tracks through use of the package description file;
(F) said controllers are bound to parameters through use of the package description file, said parameters provide values that the controllers use when they affect the tracks as a music mix is performed; and
(G) a music mix is performed for the user specified values for each parameter resulting in an audio file that may be played over a sound reproduction system or stored in an information retrieval system for later use.

2. The Method for Automating the Mixing of Multi-Track Digital Audio of claim 1 further comprising a method for generating new songs from the various tracks of some number of songs, comprising the following steps:
(H) a track is selected from an existing song;
(I) a new song is created from the selected track;
(J) said new song has one track, the selected track; and
(K) a test is performed to determine if the song is complete;
if the test succeeds, then the process stops and a new song has been created that is considered to be complete; or
if the test does not succeed, the search for a new track is started and a new track is selected for addition to the song and the process repeats until said test succeeds.

3. The Method for Automating the Mixing of Multi-Track Digital Audio of claim 1 wherein the descriptive meta-data are name, genre, or mood.

4. The Method for Automating the Mixing of Multi-Track Digital Audio of claim 1 wherein the groups combine one or more tracks with similar or shared characteristics.

5. The Method for Automating the Mixing of Multi-Track Digital Audio of claim 4 wherein the shared characteristics are drums, voices, and guitars.

6. The Method for Automating the Mixing of Multi-Track Digital Audio of claim 1 wherein the parameters are means for providing music controls with descriptive names.

7. The Method for Automating the Mixing of Multi-Track Digital Audio of claim 1 wherein the descriptive meta-data include a typical amplitude envelope for instruments in the track, as well as tempo, key, note and measure regions.

8. The Method for Automating the Mixing of Multi-Track Digital Audio of claim 1 wherein the controllers are further comprised of attributes that govern how the controller affects the associated track when a music mix is performed.

9. The Method for Automating the Mixing of Multi-Track Digital Audio of claim 1 wherein when the controllers are bound to the parameters, said parameters provide values that said controllers use when they affect the tracks as a music mix is performed.

10. The Method for Automating the Mixing of Multi-Track Digital Audio of claim 3 wherein the selection is performed by a user, or by an algorithmic method.

11. The Method for Automating the Mixing of Multi-Track Digital Audio of claim 10 wherein the algorithmic method is a search based on genre or mood.

12. The Method for Automating the Mixing of Multi-Track Digital Audio of claim 3, when the test is performed to determine if the song is complete, the song may be considered to be complete when two cases are considered to be true:
said song has a sufficient amount of tracks such that all of the song parameters affect the music mix, and
all tracks are considered to be suitable for a combination given some set of musical criteria.

13. The Method for Automating the Mixing of Multi-Track Digital Audio of claim 12 wherein song parameters affect the music mix when any change in the value of all parameters has an effect on the output of said music mix.

14. The Method for Automating the Mixing of Multi-Track Digital Audio of claim 12 wherein the set of musical criteria includes tempo and pitch.

15. An Apparatus and system for Automating the Mixing of Multi-Track Digital Audio consisting of:
one or more Adaptable Music Files; and
software means performing a music mix for the user specified values for each parameter resulting in an audio file that may be played over a sound reproduction system or stored in an information retrieval system for later use.

16. The Apparatus and system for Automating the Mixing of Multi-Track Digital Audio of claim 15 wherein the apparatus and system also consist of:
a song file, and
software providing
a package description file which tags a song with descriptive meta-data;
adding groups to the song through use of the package description file;
adding parameters to the song through use of the package description file;
tags tracks with meta-data through use of the package description file; and
adding controllers to the tracks through use of the package description file resulting in an Adaptable Music File that may be used by the apparatus and system for later use.

17. The Apparatus and system for Automating the Mixing of Multi-Track Digital Audio of claim 15 wherein the a Digital Audio Workstation is comprised of a computer-based system of interacting components consisting of:
a buss,
an input device,
a display device,
a CPU,
storage media for storing the program steps for the system's processing;
a memory for storing any data resulting from or the system's processing; and
an audio device.

18. The Apparatus and system for Automating the Mixing of Multi-Track Digital Audio of claim 16 wherein the audio device is either
a component of the computer; or
a device external to the computer such as a digital to analog audio converter.

19. The Apparatus and system for Automating the Mixing of Multi-Track Digital Audio of claim 17 wherein the audio device is connected to one or more additional audio devices.

20. The Apparatus and system for Automating the Mixing of Multi-Track Digital Audio of claim 16 wherein the output audio data is in a format enabling the audio device to produce audio.

21. The Apparatus and system for Automating the Mixing of Multi-Track Digital Audio of claim 19 wherein the output audio data format is a sequence of floating point numbers representing multi-channel audio.
